(19) United States
(12) Patent Application Publication
(10) Pub. No.: US 2004/0130812 A1
(43) Pub. Date: Jul. 8, 2004

(54) Mirror support device of simple construction that can be formed at low cost and that is of excellent stability

(75) Inventor: Yoshinori Kondo, Sagamihara-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Olympus Corporation, Tokyo (JP)

(21) Appl. No.: 10/738,284

(22) Filed: Dec. 16, 2003

(30) Foreign Application Priority Data
Dec. 25, 2002 (JP) 2002-375156

(51) Int. Cl. G02B 7/182

(52) U.S. Cl. 359/872; 248/479

(57) ABSTRACT

The mirror and coil and other elements are mounted on the coil holder constituting a moveable unit and this is supported so as to be tiltable (rotatable) with respect to a magnet holder constituting a fixed member, by means of springs serving as support members. A hinge for the portions that are freely rotatably supported about axes of rotation Ox, Oy can be formed easily by introducing adhesive from the hole of a projection in the middle of an arm of which two ends are fixed in the magnet holder to a seat provided on the rear face of the mirror opposite and adjacent thereto and curing in a condition in which a bridge is formed between these two members. Thanks to the provision of the seat, stable size and shape of the adhesive to be applied can be formed, thereby making it possible to manufacture a mirror support device with matching characteristics.

This application claims benefit of Japanese Application No. 2002-375156 filed in Japan on Dec. 25, 2002, the contents of which are incorporated by this reference.

### BACKGROUND OF THE INVENTION

1. Field of the Invention

The present invention relates to a mirror support device that is employed in an optical device such as for example a magnetic disk drive, recordable disk drive, write-once disk drive, information recording/reproduction device that records and/or reproduces information in respect to optical recording media such as an optical card, CD-ROM, or DVD, optical scanner or optical deflection device for optical communication.

2. Description of the Related Art

Mirror support devices are employed for inclining luminous flux in optical devices such as magnetic disk drives, recordable disk drives, write-once disk drives, information recording/reproduction devices that record and/or reproduce information in respect to optical recording media such as optical cards, CD-ROMs or DVDs, or in optical devices such as optical scanners.

In optical recording media such as for example information recording/reproducing devices, in order to increase the recording capacity, the track separation approaches the order of microns and in order to achieve accurate recording/reproduction of information, generally a coarse actuator that drives the optical head in a broad range in the radial direction of the disk and a fine actuator for performing precision tracking action are employed; one type of fine actuator is a galvano-mirror or mirror support device.

An example of such a galvano-mirror construction is disclosed in Laid-open Japanese Patent Application No. H. 4-337527, FIG. 27 and FIG. 28a to FIG. 28n.

An example of a prior art construction will be described with reference to FIG. 27. This galvano-mirror comprises: a reflecting mirror 80, a support 82 that supports this reflecting mirror 80; a hinge unit 83 that is formed on this support 82; at least two coils 81 that are arranged at substantially the same distance from a virtual plane parallel with the reflecting surface of the reflecting mirror 80, passing through this hinge unit 83, and coupled with this reflecting mirror 80 so as to pass through the side face of the reflecting mirror 80; and permanent magnets 86, 87 arranged so as to face a portion of these coils 81 positioned at the side face of the mirror; wherein the coils 81 are formed in a substantially rectangular shape so as to surround the support 82 seen from the direction facing the reflecting surface.

The construction of the hinge unit 83 is as follows.

Specifically, the hinge unit 83 is made of temperature-flexible polyester elastomer material and comprises a hinge formed in a mould, this hinge unit 83 being integrally supported on a base 84 so that the mirror 80 can be rotated in substantially any desired direction.

Also, the manufacturing process of the hinge unit 83 is as shown in FIG. 28.

(1) First of all, a circular concave 91 is formed in a semiconductor substrate 90 and electrodes 92 of an electrostatic actuator are formed along the circumference of the flat bottom face of this concave 91 (FIG. 28a, FIG. 28b).

(2) Next, a step-shaped projection 94 is formed by repeated deposition and etching of polysilicon layers 93 (FIG. 28c to FIG. 28h).

(3) Next, an SiO₂ layer 95 constituting a sacrificial layer is formed (FIG. 28i) and the middle 96 thereof is etched (FIG. 28j);

(4) In addition, a polysilicon layer 97 is deposited (FIG. 28k);

(5) etching is performed with the exception of the vicinity of the middle (FIG. 28l)

(6) and, furthermore, the sacrificial layer 95 is removed (FIG. 28m);

(7) thereby completing a support having a hinge unit 98.

(8) After this, the mirror 80 is stuck onto the support having a hinge unit 98 (FIG. 28n) and a galvano-mirror having at least three electrodes 92 arranged in a fixed region at substantially the same distance from a virtual plane parallel with the reflecting surface of the mirror 80 passing through the hinge unit 98 is completed by supporting the mirror 80 in rotatable fashion.

The operation of this prior art example is described below.

Charge is generated on an electrode 92 by applying a voltage to the electrode 92 formed in the concave 91 of the semiconductor substrate 90, and, since the mirror surface is constituted by a dielectric, charge of the opposite polarity is induced by dielectric polarization at a position facing the electrode 92.

Electrostatic attractive force is thereby generated between the electrode 92 and the mirror and the mirror 80 is rotated utilizing this force. As described above, the axis of rotation of the galvano-mirror is determined by changing the electrode 92 to which the voltage is applied; suitable voltages may be applied to one or two of the corresponding electrodes 92.

### SUMMARY OF THE INVENTION

An object of the present invention is to provide a mirror support device of simple construction that can be formed at low cost and that is of excellent stability.

A mirror support device according to the present invention comprises a moveable unit having at least one mirror, a support unit that supports this moveable unit so as to be tiltable about at least a first axis with respect to a fixed member, a first drive unit that drives the moveable unit about the first axis, and a hinge introduced between the first location and the second location, and disposed in substantially the middle of the moveable unit, the first location or second location or both locations comprising a concave face or a convex face.

Other characteristic features and advantages of the present invention will become clear from the following description.

### BRIEF DESCRIPTION OF THE DRAWINGS

FIG. 1 to FIG. 19B relate to a first embodiment.

FIG. 1 is a constructional diagram of an optical path changeover device incorporating the present invention;

FIG. 2 is a perspective view showing the construction of a mirror support device according to a first embodiment of the present invention;

FIG. 3 is an exploded perspective view of FIG. 2;

FIG. 4 is a perspective view seen from the side face on the opposite side of FIG. 2;

FIG. 5 is a perspective view showing the construction at the side face on the opposite side of the FPC and PSD in FIG. 3;

FIG. 6 is a sectional view, based on a cross-section in the height direction of FIG. 2, showing the construction of a tilt sensor that detects mirror tilting;

FIG. 7 is a perspective view showing to a large scale the optical deflector of FIG. 3;

FIG. 8 is a perspective view showing the construction of an optical deflector seen from the rear face side of FIG. 7;

FIG. 9 is an exploded perspective view of an optical deflector;

FIG. 10 is a sectional view showing to a larger scale an optical deflector portion in FIG. 6;

FIG. 11 is a view showing a magnet holder and coil holder wherein springs are insertion-molded;

FIG. 12A is a first plan view showing a hinge structure portion;

FIG. 12B is a second plan view showing a hinge structure portion;

FIG. 13A is a first diagram of the case where forming is effected by inflow of adhesive from the hole of an arm, principally relating to a method of applying adhesive, in a process for forming a hinge;

FIG. 13B is a second diagram of the case where forming is effected by inflow of adhesive from the hole of an arm, principally relating to a method of applying adhesive, in a process for forming a hinge;

FIG. 14A is a first diagram of the case where separation and forming are effected after two members have been brought together after inflow of adhesive from a hole of an arm according to a modified example of FIG. 13;

FIG. 14B is a second diagram of the case where separation and forming are effected after two members have been brought together after inflow of adhesive from a hole of an arm according to a modified example of FIG. 13;

FIG. 14C is a third diagram of the case where separation and forming are effected after two members have been brought together after inflow of adhesive from a hole of an arm according to a modified example of FIG. 13;

FIG. 15A is a first diagram of the case where separation and forming are effected after inflow of adhesive from a hole of an arm in a condition with two members brought together, when a hinge is formed;

FIG. 15B is a second diagram of the case where separation and forming are effected after inflow of adhesive from a hole of an arm in a condition with two members brought together, when a hinge is formed;

FIG. 16A is a first diagram of the case where separation and forming are effected after two members have had adhesive applied thereto and been brought together, when a hinge is formed;

FIG. 16B is a second diagram of the case where separation and forming are effected after two members have had adhesive applied thereto and been brought together, when a hinge is formed;

FIG. 16C is a third diagram of the case where separation and forming are effected after two members have had adhesive applied thereto and been brought together, when a hinge is formed;

FIG. 17A is a first diagram of the case where separation and forming are effected after adhesive has been applied to two members in a condition with the two members brought together, when a hinge is formed;

FIG. 17B is a second diagram of the case where separation and forming are effected after adhesive has been applied to two members in a condition with the two members brought together, when a hinge is formed;

FIG. 18A is a first diagram of the case where separation and forming are effected after adhesive has been applied to a mirror seat and two members have been brought together, when a hinge is formed;

FIG. 18B is a second diagram of the case where separation and forming are effected after adhesive has been applied to a mirror seat and two members have been brought together, when a hinge is formed;

FIG. 18C is a third diagram of the case where separation and forming are effected after adhesive has been applied to a mirror seat and two members have been brought together, when a hinge is formed;

FIG. 19A is a first view showing a model example and an actual example of a method of controlling position when curing is effected after application of adhesive; and

FIG. 19B is a second view showing a model example and an actual example of a method of controlling position when curing is effected after application of adhesive.

FIG. 20A to FIG. 26 relate to a second embodiment.

FIG. 20A is a first diagram showing the case where a seat is formed on at least one of an arm and mirror to which adhesive has been applied when forming a hinge, and a modified example thereof;

FIG. 20B is a second diagram showing the case where a seat is formed on at least one of an arm and mirror to which adhesive has been applied when forming a hinge, and a modified example thereof;

-FIG. 21A is a first diagram, corresponding to a first modified example, of the case where at least one of an arm and mirror to which adhesive is applied when forming a hinge is made as a hemispherical surface;

FIG. 21B is a second diagram, corresponding to a first modified example, of the case where at least one of an arm and mirror to which adhesive is applied when forming a hinge is made as a hemispherical surface;

FIG. 21C is a third diagram, corresponding to a first modified example, of the case where at least one of an arm and mirror to which adhesive is applied when forming a hinge is made as a hemispherical surface;

FIG. 22A is a first diagram, corresponding to a second modified example, of the case where at least one of an arm and mirror to which adhesive is applied when forming a hinge is made as a conical surface;

FIG. 22B is a second diagram, corresponding to a second modified example, of the case where at least one of an arm and mirror to which adhesive is applied when forming a hinge is made as a conical surface;

FIG. 22C is a third diagram, corresponding to a second modified example, of the case where at least one of an arm and mirror to which adhesive is applied when forming a hinge is made as a conical surface;

FIG. 23A is a first diagram, corresponding to a third modified example, of the case where at least one of an arm and mirror to which adhesive is applied when forming a hinge is made as a concave;

FIG. 23B is a second diagram, corresponding to a third modified example, of the case where at least one of an arm and mirror to which adhesive is applied when forming a hinge is made as a concave;

FIG. 23C is a third diagram, corresponding to a third modified example, of the case where at least one of an arm and mirror to which adhesive is applied when forming a hinge is made as a concave;

FIG. 24A is a diagram, corresponding to a fourth modified example, of the case where the concave of FIG. 23A is constituted as a spherical concave;

FIG. 24B is a diagram, corresponding to a fourth modified example, of the case where the concave of FIG. 23B is constituted as a spherical concave;

FIG. 24C is a diagram, corresponding to a fourth modified example, of the case where the concave of FIG. 23C is constituted as a spherical concave;

FIG. 25A is a first diagram, corresponding to a fifth modified example, of the case where one of the arm and mirror to which adhesive is applied when a hinge is formed constitutes a concave while the other constitutes a projection;

FIG. 25B is a second diagram, corresponding to a fifth modified example, of the case where one of the arm and mirror to which adhesive is applied when a hinge is formed constitutes a concave while the other constitutes a projection;

FIG. 26 is a diagram of the case where an arm is constituted as a single-handled arm;

FIG. 27 is a view showing the construction of a prior art example of a galvano-mirror;

FIG. 28a is a first diagram of a manufacturing process of a prior art example of a hinge;

FIG. 28b is a second diagram of a manufacturing process of a prior art example of a hinge;

FIG. 28c is a third diagram of a manufacturing process of a prior art example of a hinge;

FIG. 28d is a fourth diagram of a manufacturing process of a prior art example of a hinge;

FIG. 28e is a fifth diagram of a manufacturing process of a prior art example of a hinge;

FIG. 28f is a sixth diagram of a manufacturing process of a prior art example of a hinge;

FIG. 28g is a seventh diagram of a manufacturing process of a prior art example of a hinge;

FIG. 28h is an eighth diagram of a manufacturing process of a prior art example of a hinge;

FIG. 28i is a ninth diagram of a manufacturing process of a prior art example of a hinge;

FIG. 28j is a tenth diagram of a manufacturing process of a prior art example of a hinge;

FIG. 28k is an eleventh diagram of a manufacturing process of a prior art example of a hinge;

FIG. 28l is a twelfth diagram of a manufacturing process of a prior art example of a hinge;

FIG. 28m is a thirteenth diagram of a manufacturing process of a prior art example of a hinge; and

FIG. 28n is a fourteenth diagram of a manufacturing process of a prior art example of a hinge.

### DESCRIPTION OF THE PREFERRED EMBODIMENTS

(First Embodiment)

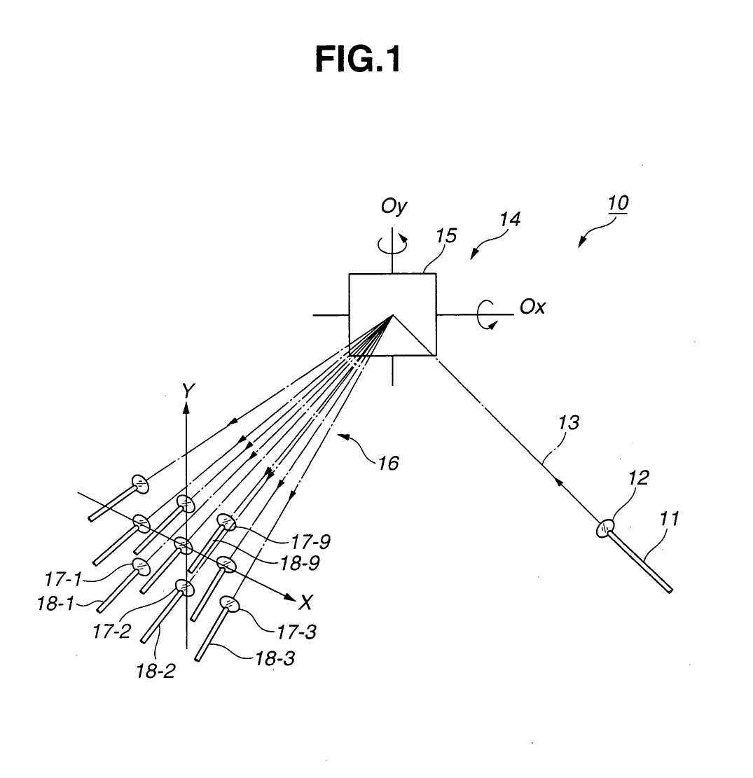

FIG. 1 to FIG. 11 show a first embodiment of the present invention. FIG. 1 shows an example in which the present invention is applied to an optical path changeover device for optical communication.

As shown in FIG. 1, in the case of the optical path changeover device 10, the light for signal transmission for optical communication that is emitted from a single optical fiber 11 is converted into a collimated beam by a collimator lens 12 and the beam 13 emitted therefrom is directed onto a mirror 15 constituting a mirror support device (or galvano-mirror) 14. The reflected beam 16 that is reflected by this mirror 15 is selectively made incident on one of a total of nine lenses 17-1 to 17-9 arranged in three stages on a plane substantially perpendicular to this reflected beam 16 and is thereby selectively made incident on one of nine optical fibers 18-1 to 18-9.

By tilting the mirror 15 about its axis of rotation Oy, the reflected beam 16 at this mirror 15 is deflected in the X direction, which is the left/right direction of FIG. 1 and by tilting the mirror 15 about the axis of rotation Ox, the reflected beam 16 at this mirror 15 is deflected in the Y direction, which is the vertical direction of FIG. 1; the beam is thereby selectively made incident on the nine lenses 17-1 to 17-9 and thereby selectively made incident on the optical fibers 18-1 to 18-9.

The optical fiber that outputs the light from the single optical fiber 11 on the incident side is thereby selected from among the nine optical fibers 18-1 to 18-9.

This mirror support device 14 basically comprises a support drive mechanism that supports and tilts the mirror 15 constituting the mirror support device 14 about the two orthogonal axes Ox, Oy, and a sensor unit that detects the (tilting) angle of the tilted mirror 15 in the directions of the two axes.

Also, the support drive mechanism comprises a mirror 15, a coil holder 31 constituting a moveable unit housing tiltable in two directions and holding a coil for driving this mirror, and a magnet holder 32 constituting a fixed member that holds a yoke and a magnet that acts magnetically opposite the coil.

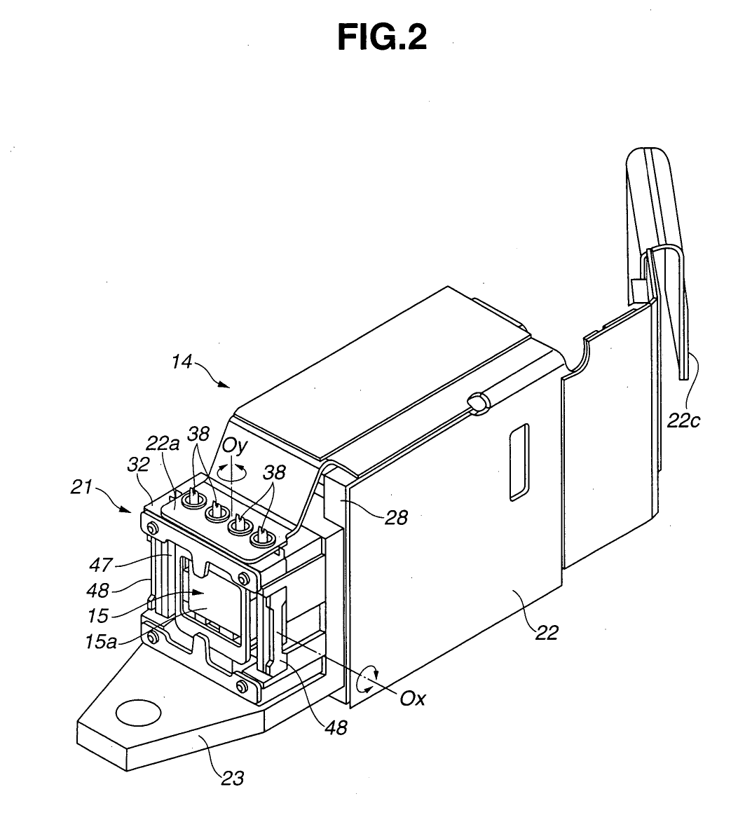

Next, a specific construction of the mirror support device 14 will be described with reference to FIG. 2 to FIG. 11.

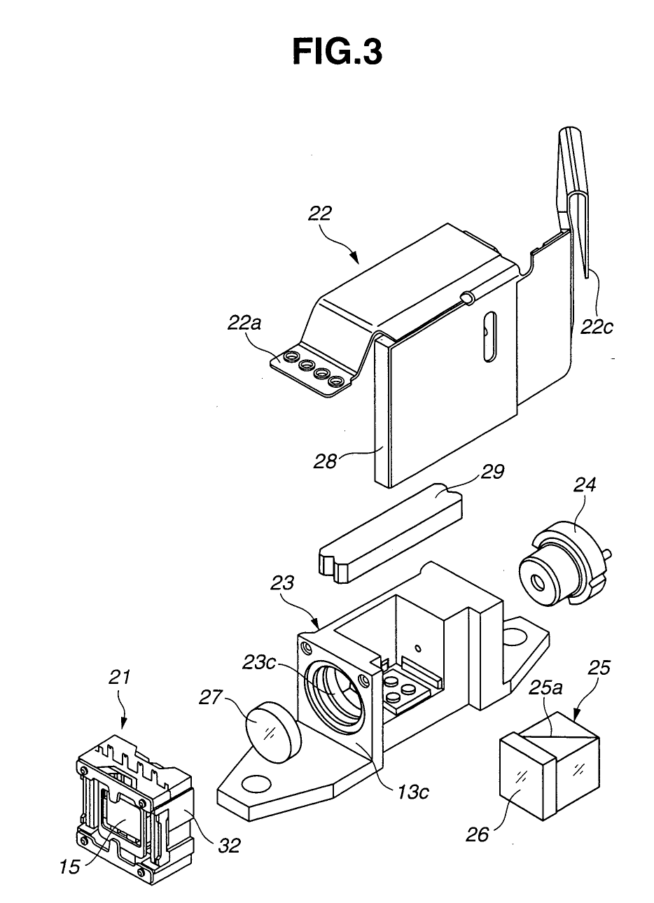

As shown in exploded form in FIG. 3, the mirror support device 14 shown in FIG. 2 comprises: a mirror 15; an optical deflector 21 that performs beam deflection, a flexible printed card (abbreviated as FPC) 22 on which is mounted an IC 30 including for example a drive circuit that supplies drive current to a first coil 36 and a second coil 37, to be described later, of this optical deflector 21; a housing 23 in which is mounted the optical deflector 21 and other items; a semiconductor laser 24 constituting a light source of a tilt sensor that detects tilting of the mirror 15; a polarizing beam splitter (abbreviated as PBS) 25 that reflects or transmits in accordance with the polarization condition; a ¼ wavelength plate 26 that applies an optical path difference (phase difference) of ¼ wavelength to linearly polarized beams oscillating in mutually orthogonal directions; a condensing lens 27 that concentrates the laser beam; a semiconductor position detector (PSD) 28 that detects the laser beam and the two-dimensional position thereof; and a spacer 29 arranged on the upper surface of the housing 23.

The housing 23 in which the optical deflector 21 and other items are mounted is formed with a substantially cubical accommodating space in which the PBS 25 and the ¼ wavelength plate 26 that is joined thereto are accommodated, the front face of the front wall forming this accommodating space being flat and constituting a mounting face 23a where the optical deflector 21 is mounted, and a tilt sensor that detects tilt of the reflecting face 15a of the mirror 15 being provided at the rear face side thereof.

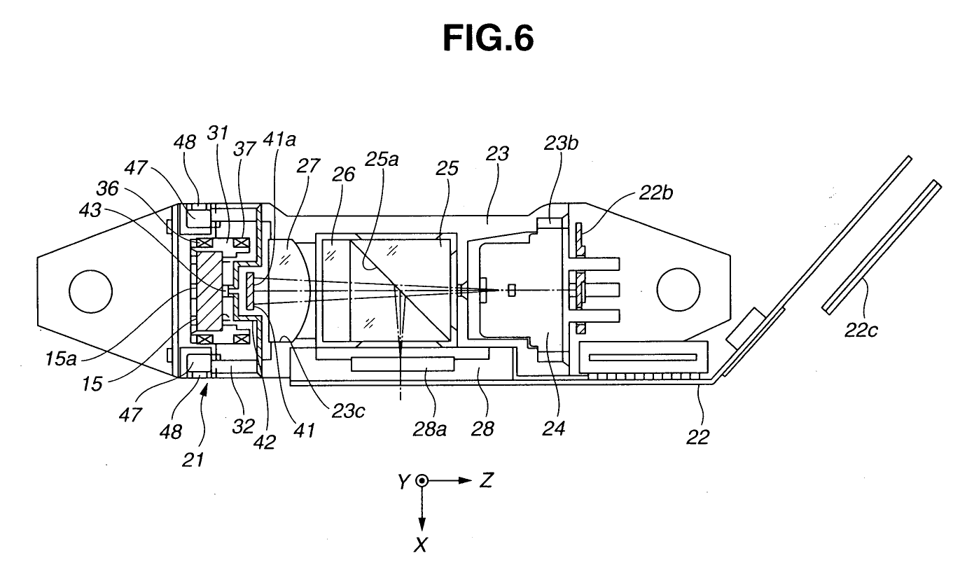

As shown in FIG. 6, a concave (aperture) 23b formed at the rear face side is formed in the rear wall, which is of increased thickness, forming the accommodating space in the housing 23 and a sensor light source constituted by a semiconductor laser 24 is positionally located and fixed by press fitting therein so that the laser beam that is emitted through the optical window of this semiconductor laser 24 is directed, as a P-polarized beam, onto a PBS 25 that is stuck onto a seat formed at the bottom face of the accommodating space at the front thereof, by means of a hole formed at a position opposite this optical window.

This PBS 25 is provided with a dielectric multi-layer film on an inclined face that is joined with two triangular prisms, so as to form a polarizing face 25a with characteristics such that P-polarized light is transmitted and S-polarized light is reflected. A ¼ wavelength plate 26 is mounted by joining at the face on the transmitted beam side of this PBS 25 so that the P-polarized beam becomes a circularly polarized beam.

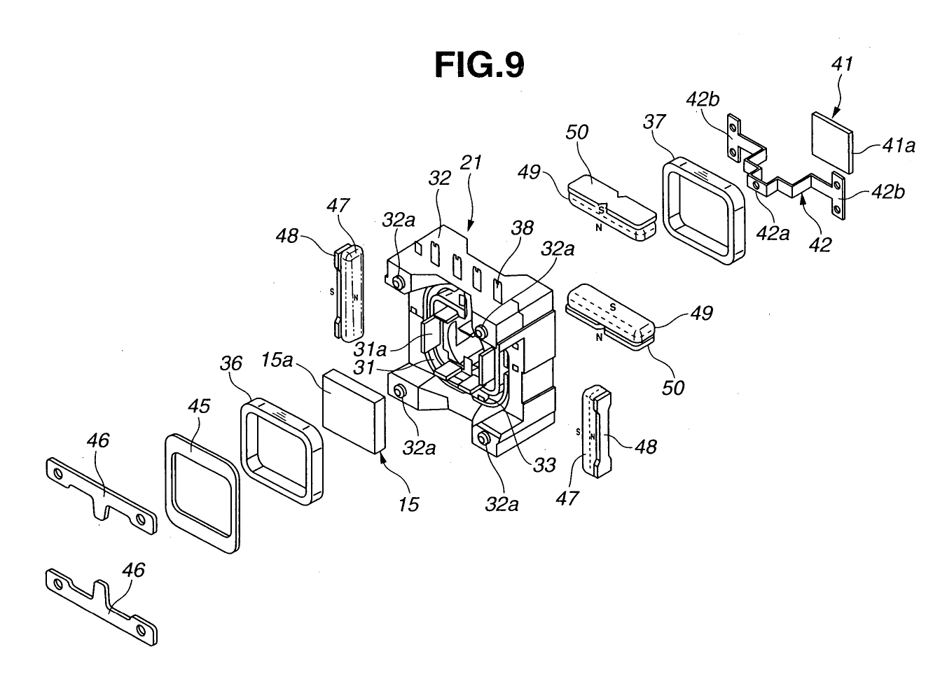

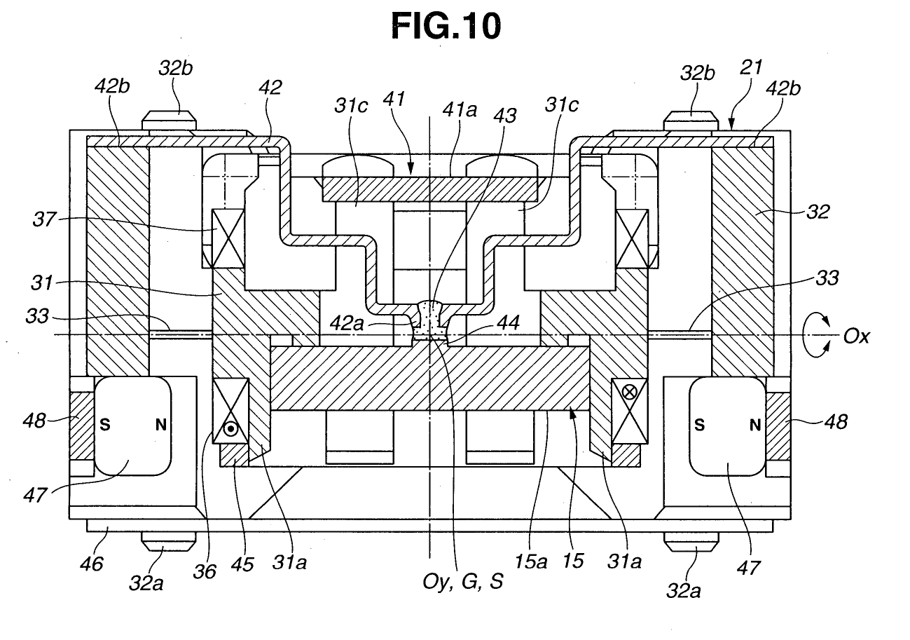

As shown in FIG. 3 and FIG. 6, a circular aperture 23c is formed in the front wall of the housing 23 opposite this ¼ wavelength plate 26 and a condensing lens 27 is adhesively mounted by being inserted therein, so that the beam that passes through the ¼ wavelength plate 26 is concentrated by this condensing lens 27 and is thereby directed onto the reflecting face 41a on the rear face side of a mirror 41 that is mounted at the rear face side of the optical deflector 21, as shown in FIG. 6, FIG. 9, FIG. 10 and other Figures.

Also, as shown in FIG. 6, the side face of the housing 23 through which the beam proceeds that is reflected at the polarizing face 25a of the PBS 25 is open and a PSD 28 is mounted in this aperture portion, so that the light that is reflected at the joining face 25a of the PBS 25 is directed in a focused condition, in the form of a spot, onto a photoreception surface 28a of this PBS 28.

This PSD 28 is a two-dimensional sensor that detects the central position of the amount of light in two orthogonal directions of the beam that is directed onto this photoreception surface 28a in the form of an electric current.

That is, it is arranged to be capable of detecting the tilt of the surface of the mirror 41 by means of the spot position of the beam that is directed onto the photoreception surface 28a and to be capable of detecting the tilt of the reflecting face 15a of the mirror 15 from the tilt of the face of this mirror 41, as will be described later.

As this PSD 28, for example an S5990-01 or S7848-01 or the like manufactured by Hamamatsu Photonics Ltd. may be employed. This PSD 28 is soldered on to the FPC 22 as shown in FIG. 3.

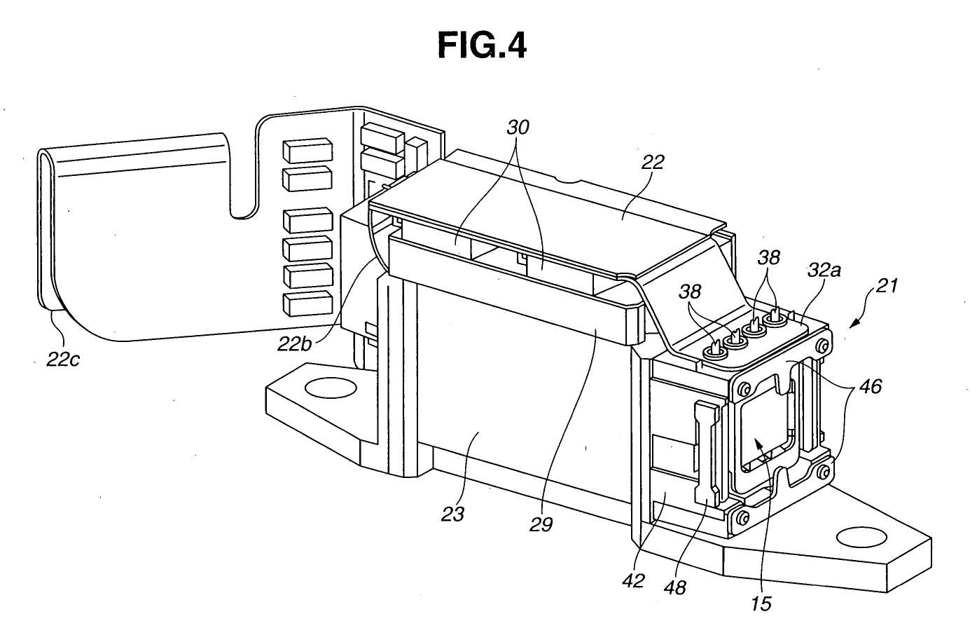

It should be noted that, as shown in this FIG. 3, the upper face side of the accommodating space in the housing 23 is open and, as shown in FIG. 4, the FPC 22, on which is mounted an IC 30 constituting a drive circuit, is mounted therein by means of a spacer 29.

As shown in FIG. 3, this FPC 22 is electrically connected with the optical deflector 21 by soldering planes 22a at the front end face thereof being linked in the vicinity of its middle with the PSD 28 and the front end thereof being bent so as to face downwards in inclined fashion, then being bent in the opposite direction so as to constitute a horizontal face.

For example, as shown in FIG. 4, four through-holes are provided in a portion of the soldering planes 22a at the front end face of the FPC 22 and solder fixing is effected by means of four terminals 38 projecting from the top face of the optical deflector 21; drive current for the drive circuit can thereby be supplied to the first coil 36 and second coil 37, to be described later, in the optical deflector 21.

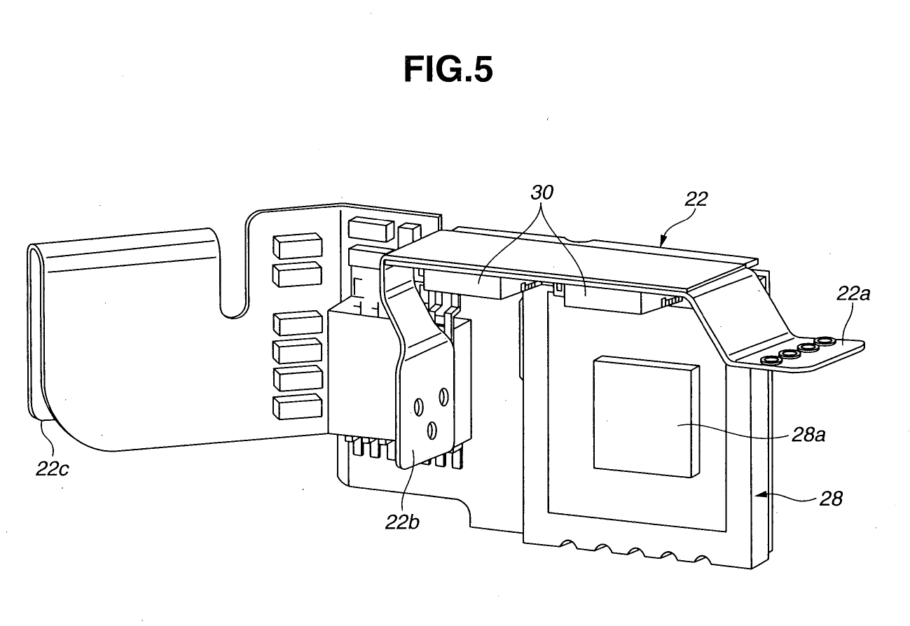

Also, soldering planes 22b extend at the rear end side as shown in FIG. 5 of this FPC 22, three through-holes provided in this soldering plane 22b being fixed by soldering with electrode pins of the semiconductor laser 24 as shown in FIG. 6; the FPC 22 can thereby be electrically connected with the semiconductor laser 24, so that the semiconductor laser 24 can be driven to emit light.

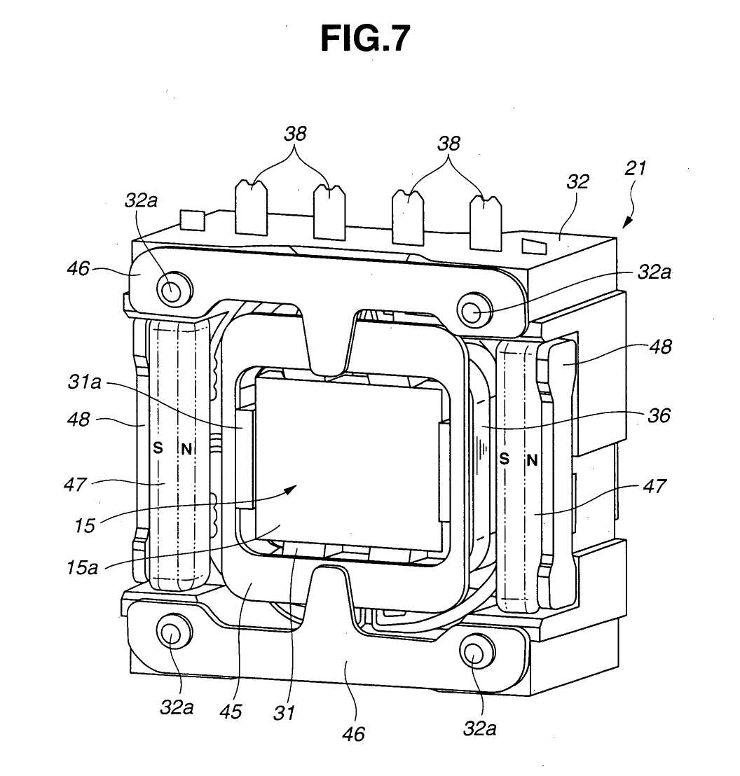

Next, the construction of the optical deflector 21 will be described with reference chiefly to FIG. 7 to FIG. 11.

The optical deflector 21, as shown in exploded fashion in FIG. 9, is integrally formed by insertion molding thin plate-shaped springs 33 in a magnet holder 32 constituting a fixed unit, and a coil holder 31 constituting a moveable unit, arranged inside this magnet holder 32.

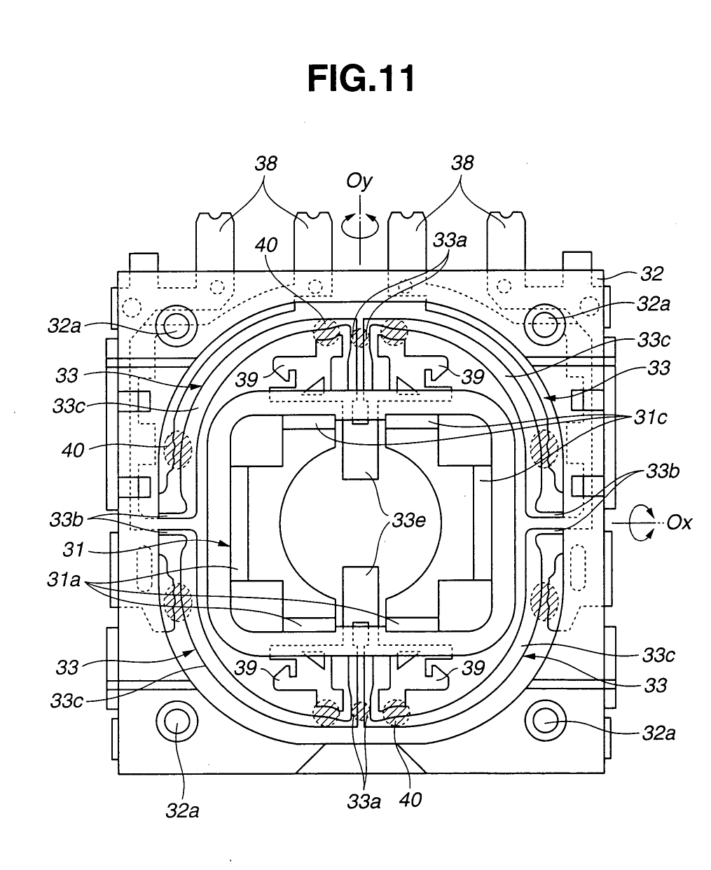

Specifically, the coil holder 31 and magnet holder 32 are molded of liquid-crystal polymer, which is a non-conductive plastic, containing for example titanium oxide whiskers and, during this process, as shown in detail in FIG. 11, the ends on the side of the moveable unit of four springs 33 made of beryllium copper foil of thickness 20 ìm whose surfaces have been gold-plated after etching are insertion-molded in the coil holder 31 while the ends on the side of the fixed unit are insertion-molded in the magnet holder 32, each of springs 33 thus being held at both ends.

Each spring 33 comprises a linkage section 33c formed in arcuate shape formed in substantially quarter arc shape, a first deformation section 33a constituted by bending one end of the linkage section 33c at right angles and extending for example parallel to the axis of rotation Oy and a second deformation section 33b constituted by bending the other end at right angles and extending for example parallel to the axis of rotation Ox. In other words, the first and second deformation sections 33a and 33b extending respectively parallel with the axes of rotation Oy and Ox are linked by a linkage section 33c of arcuate shape.

These four springs 33 are arranged along the substantially circular inner circumferential surface of the magnet holder 32 and so as to form substantially a circle surrounding the four corners of the coil holder 31; in this case, two pairs of first deformation sections 33a each pair consisting of two 33a arranged parallel to and adjacent to the axis of rotation Oy, the ends thereof being held by the upper end and lower end of the coil holder 31; also, two pairs of second deformation sections 33b each pair consisting of two 33b arranged parallel to and adjacent to the axis of rotation Ox, the ends thereof being held by the left and right ends of the magnet holder 32.

It should be noted that the four springs 33 described above are those constituted after cutting off the linkage section 33e after molding. During molding, as shown in FIG. 11, the ends of the first deformation section 33a that are held by the upper end and lower end of the coil holder 31 are extended as far as the middle side of the coil holder 31 and two left and right springs 33 are integrally linked by means of the linkage section 33e.

The four springs 33 can then be obtained by respectively cutting off the linkage section 33e on the side of the middle after molding. In this way, positional location of the springs 33 with respect to the mold on the side of the coil holder 31 during insertion molding, and holding thereof are facilitated, making it possible to achieve more precise insertion molding in the coil holder 31.

Also, although, as described above, the linkage section 33e on the side of the middle is cut off after molding of the portion of the springs 33 that extends towards the middle of the coil holder 31, the outwardly extending portion of the coil holder 31 constitutes a solder fixing portion 39 to which the terminal portions of the coils 36, 37 that are mounted on the coil holder 31 are soldered.

The end of the second deformation section 33b is inserted in the magnet holder 32 and this insertion portion passes through the middle of the magnet holder 32 and respectively reaches the four terminals 38. The four terminals 38 are then soldered onto the solder fixing portions 22a of the end face side of the FPC 22, so that power can be supplied to the two coils 36, 37 through the four springs 33 by supplying power from this FPC 22.

As shown in FIG. 11, the two adjacent first deformation sections 33a, a linkage section 33c and solder fixing portion 39, and a linkage section 40c and the magnet holder 32 are attached so as to be linked by dampers 40 constituted by silicon gel, cured by UV or the like, so that damping is achieved of the two ends of the springs 33.

The mirror 15 is adhesively fixed to the coil holder 31 with its reflecting face 15a at the front face of the periphery of the middle circular aperture of the coil holder 31 being the outside face side and the peripheral position thereof being determined by a positional location section 31a and its rear face adhesively fixed to the coil holder 31. The reflecting face 15a at the front face of this mirror 15 is coated with gold or a dielectric multi-layer film so as to have a high reflectivity chiefly for light of wavelength 1.5 ìm.

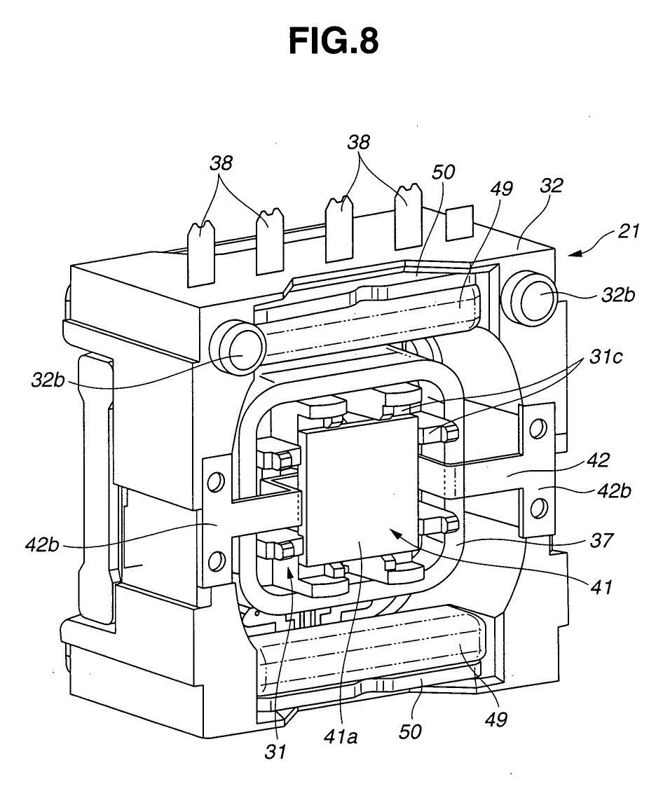

A mounting section 31c (see FIG. 8 and FIG. 10) is formed on the side of the condensing lens 27 at the rear face of the coil holder 31, the mirror 41, constituted by a silicon wafer of thickness 0.2 mm, being adhesively fixed, with its periphery located in position on this mounting section 31c. The reflective face 41a of the mirror 41 is coated with gold so as to have a high reflectivity for light of 780 nm wavelength for sensor use.

As respectively shown in FIG. 7 and FIG. 8, the inner sides of the first coil 36 and the second coil 37 are positionally located by stepped faces on the outside of respective positional location sections 31a, 31c at the periphery of both faces of the coil holder 31 and are adhesively fixed after thus being located in position on the coil holder 31.

As shown in FIG. 10, a gap is present between the two mirrors 15 and 41 and the middle of an arm 42 produced by forming a stainless steel plate of thickness 0.1 mm in bent fashion is positioned in this gap portion (its outer shape is also shown in FIG. 9), being arranged so as to surround the periphery of the mirror 41, with its two ends 42b adhesively fixed to the magnet holder 32.

As shown in FIG. 10, a projection 42a with a hole formed in the middle thereof is formed in the middle of this arm 42 and is arranged with a gap of for example 0.3 mm with respect to the rear face of the mirror 15.

A substantially cylindrical hinge (or pivot) 43 is formed by introducing a damping agent capable of retaining its own shape and comprising for example a silicone adhesive between this projection 42a and the mirror 15 and is cured at normal temperature or, if necessary, is cured by UV or heat or the like.

That is, the hinge 43 that supports the moveable unit in a tiltable fashion is formed by introducing (or applying) liquid adhesive between the two members constituted by the middle projection 42a of the arm 42, constituting a fixed member, and the middle of the rear face of the mirror 15, constituting a moveable unit.

In this case, setting is effected such that the centers of rotation Ox, Oy and the center of gravity G of the moveable unit are positioned in the middle of this hinge 43.

Also, in this embodiment, a convex seat 44 for forming in stable fashion the portion where the silicone adhesive is to be applied is provided in the middle of the rear face of the mirror 15 opposite the projection 42a.

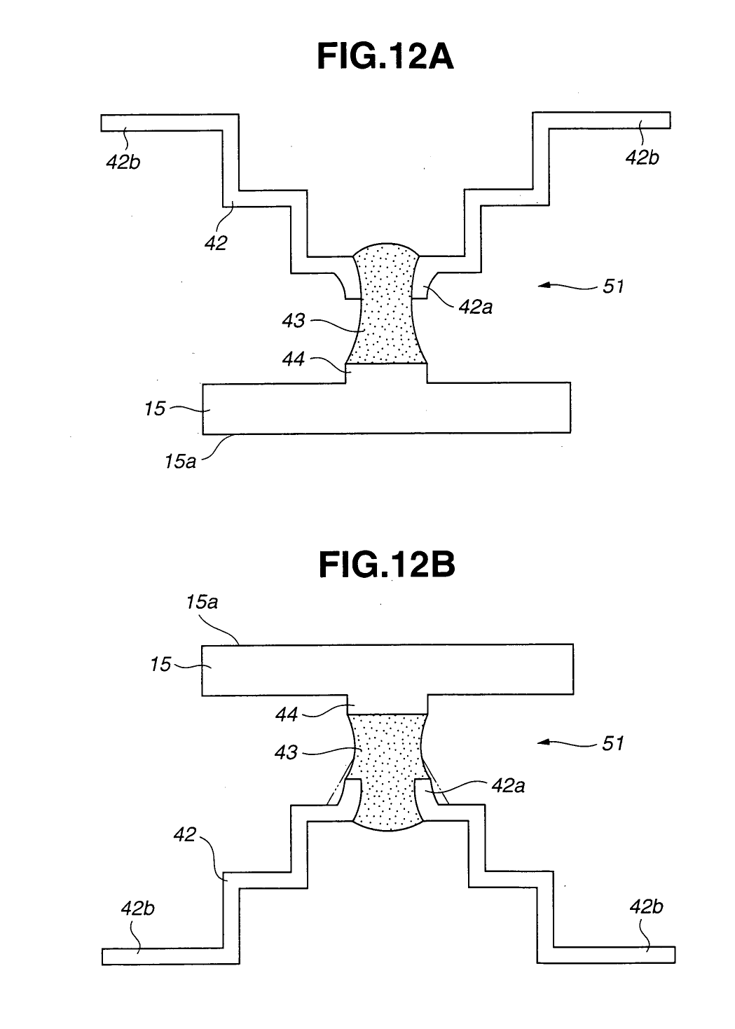

Thus, in this embodiment, by forming a convex seat 44 as shown in FIG. 12A and FIG. 12B, in which this portion is shown in a larger scale, on the side of formation of the hinge 43 at the rear face side of the mirror 15, a construction can be achieved whereby, when adhesive is applied, forming can be performed with stable shape and size of the wetting faces.

In other words, when the hinge 43 is formed by applying or introducing a liquid adhesive, it is arranged that a hinge 43 of stable area size and shape can be obtained by forming using control means such that the size of the area to which the adhesive is applied on the rear face side of the mirror 15 is controlled by means of the convex seat 44 so as to produce this seat portion.

Also, a rectangular-shaped stop 45 as shown in FIG. 9 is stuck onto the top of the coil 36. Two substantially T-shaped covers 46 are then stuck onto the front face thereof using four bosses 32a formed on the outside face of the magnet holder 32 as references.

Thus, excessive movement of the moveable unit when the moveable unit is moved in the direction perpendicular to the reflective face 15a of the mirror 15 by external vibration or the like is prevented by abutment of the middle projections of the covers 46 and the stop 45.

Also, as shown in FIG. 9, a yoke 48 for the first coil 36 is stuck onto the rear faces of two magnets 47 magnetized in for example the horizontal direction and is thereby stuck onto the magnet holder 32. Also, a yoke 50 for the second coil 37 is stuck onto the rear faces of two magnets 49 magnetized in for example the vertical direction and is thereby stuck onto the magnet holder 32.

The moveable unit is constituted by the coil holder 31, first coil 36, second coil 37, and mirrors 15 and 41. As shown in FIG. 10, the center of gravity G of the moveable unit is on the axis of rotation Ox and Oy. Also, the main initial axis S of the moveable unit coincides with the axis of rotation Ox and the axis of rotation Oy. Also, the springs 33 are arranged so as to coincide on the plane defined by the axis of rotation Ox and axis of rotation Oy. Also, the first deformation section 33a is arranged in a position substantially coincident with the axis of rotation Oy and the second deformation section 33b is arranged in a position substantially coincident with the axis of rotation Ox.

The first coil 36 is arranged in a position closer to the springs 33 than the second coil 37. In this way, the position of the center of gravity, including the mirror 15, can be made to coincide with the axes of rotation Ox, Oy without needing to use a balancer.

As shown in FIG. 3, the rectangular magnet holder 32 is located in position and adhesively fixed by fitting two bosses 32b (see FIG. 8 and FIG. 10) into holes in a mounting face 23a at the front face of the housing 23, which is molded for example by zinc die-casting.

A tilt sensor that detects the tilt of the mirror 15 is provided in the housing 23, as described above.

That is, the laser beam of a semiconductor laser 24 which is positionally located and fixed at the rear end of the housing 23 is directed onto the reflecting face 41a of the mirror 41 through the PBS 25, ¼ wavelength plate 26, and condensing lens 27 and the two-dimensional position of the beam is detected by detecting the reflected beam using a detector unit 28a of the PSD 28.

In this case, the output of the PSD 28 is input to the FPC 22. On this FPC 22, there are mounted a circuit that converts the output current of the PSD to voltage and an IC 30 comprising drive circuits for the coils 36 and 37.

As described above, the IC 30 for the driver circuits that is mounted on the FPC 22 is fixed with its upper surface abutting a spacer 29 made of aluminum that is fixed to the top of the PBS 28 of the housing 23. In this way, the spacer 29 and the housing 23 constitute heat radiating members for the IC 30. Also, solder fixing portions 22a that are provided at the front end of the FPC 22 are soldered onto the four terminals 38 of the optical deflector 21 and solder fixing portions 22b at the rear face side of the FPC 22 have three terminals of the semiconductor laser 24 soldered thereto. Also, the rear end 22c of the FPC 22 is inserted into a connector, not shown.

As shown in FIG. 12A and FIG. 12B, it is a characteristic feature of this embodiment constructed in this way that a hinge structure (pivot) 51 is formed wherein a hinge 43 is formed that constitutes a center point (fulcrum) that freely rotatably supports the mirror 15.

As shown in this FIG. 12A, this hinge structure 51 is characterized in that it comprises an arm 42 (with both ends 42b thereof fixed to the magnet holder 32, constituting the fixed unit), the mirror 15 that is fixed to the coil holder 31 and constitutes the moveable unit and a hinge 43 that is positioned in substantially the middle of the moveable unit, being formed at the rear face (back face) side of this mirror 15; and in that, in this case, a convex seat 44 is formed as an adhesive coating region of the mirror 15.

The hinge 43 is made of adhesive and the frequency characteristic (abbreviated as f characteristic) in the direction of rotation of the moveable unit and the f characteristic in the Z direction are determined by its material properties and shape. If it is desired to create a hinge structure 51 ensuring durability with little positional change, an addition-type silicone adhesive such as for example (1) JCR 6125 (Toray/Dow Corning), (2) JCR 6126 (Toray/Dow Corning), (3) SE 1821 (Toray/Dow Corning), (4) KE 1031 (Shinetsu) or (5) KE 109 (Shinetsu) may be employed. This enables a hinge structure to be obtained wherein even though the moveable unit is displaced and held in a condition directed vertically or horizontally, there is little compressive permanent strain and the moveable unit does not change its position on returning to the static condition.

Of these addition-type silicone adhesives, KE 109E (Shinetsu) and the like have the advantage of curing at normal temperature.

Also, if a single-liquid addition-type such as TSE 3221 S (GE Toshiba), FE-61 (Shinetsu) or the like is employed, mixing is not required.

Also, the hinge shape is controlled by the amount applied, the gap distance and the application area (wetting area). As shown in FIG. 12A and FIG. 12B, the provision of a convex seat 44 makes possible manufacture in straightforward fashion and at low cost of a mirror support device with stable characteristics of little variability and of a stable hinge shape, by controlling the wetting area region of the adhesive that forms the hinge 43.

FIG. 12B is a view showing the upper face side of the mirror 15. In FIG. 12A, the hinge 43 made of adhesive is formed on the inside of the hole of the projection 42a in the middle of the arm 42, but there is no restriction to this and, as shown in FIG. 12B, it would be possible to make the mirror surface of the upper side with the leading end thereof formed so as to be wetted, or to adopt a shape projecting further to the outside, as shown by the double-dotted chain line.

Next, a method of manufacturing this hinge structure 51, more specifically, a method of applying adhesive to achieve stable formation of a hinge 43 will be described.

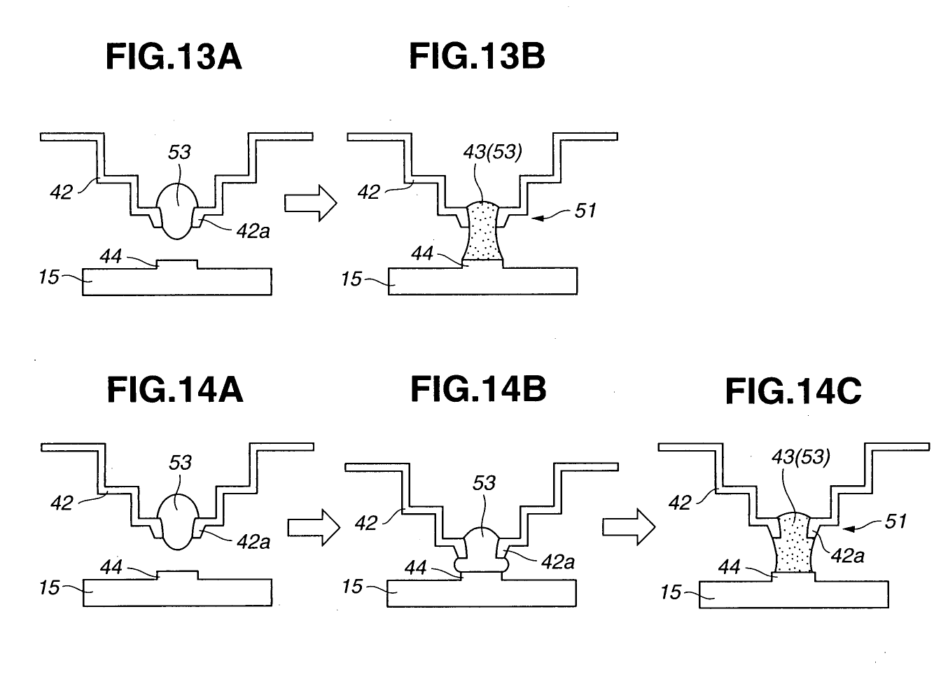

FIG. 13A to FIG. 18B illustrate a method of applying adhesive 53.

As shown in FIG. 13A, a hinge 43 may be formed by applying adhesive 53 such as silicone adhesive from above the hole of the projection 42a formed in substantially the middle of the arm 42, thereby causing the adhesive 53 to flow through this hole as far as the convex seat 44 on the side of the mirror 15 therebelow, with the adhesive 53 forming a linking bridge, as shown in FIG. 13B, spanning the arm 42 and the mirror 15, the adhesive then being cured. An effective technique is to employ adhesive that flows comparatively readily (adhesive having a viscosity of the order of 1 Pa.s to 10 Pa.s).

Also, instead of waiting for the adhesive 53 to flow in after applying the adhesive 53 from above the hole, as shown in FIG. 14A, it would also be possible to form a hinge 43 by bringing together the arm 42 and the mirror 15 as shown in FIG. 14B, thereby forming a bridge made of adhesive 53 between the arm 42 and mirror 15 in a shorter time, then separating the arm 42 and mirror 15 to a prescribed distance and curing the adhesive 53 to form a hinge 43 as shown in FIG. 14C.

With a method as shown in FIG. 14A to FIG. 14C, the time required for the adhesive 53 to flow in to the side of the mirror 15 can be shortened and bridging can be reliably achieved by the adhesive 53.

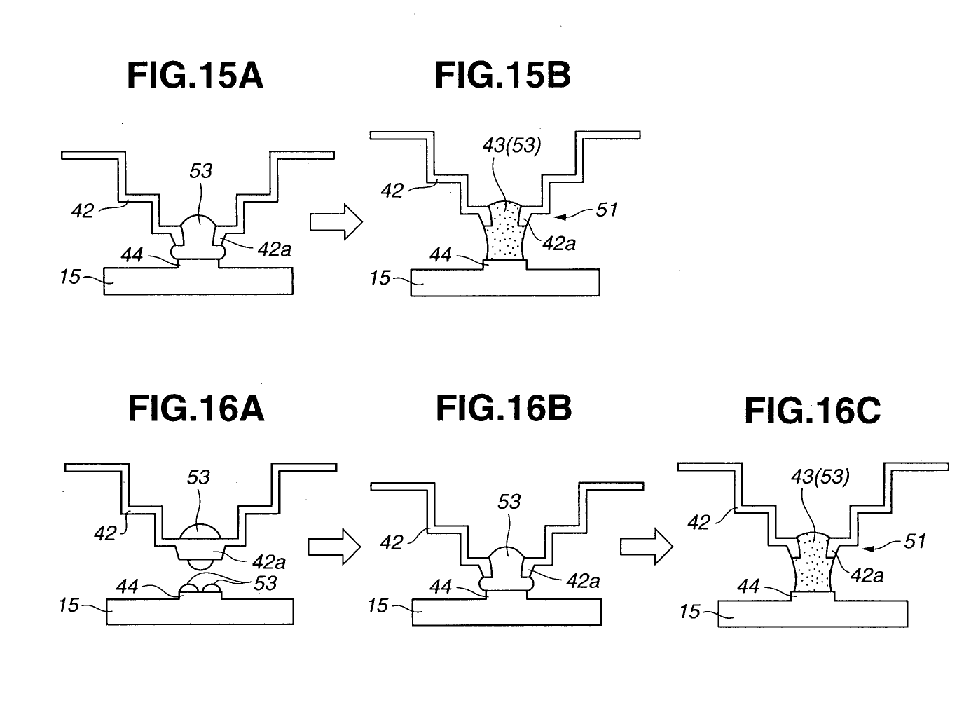

Also, as shown in FIG. 15A, it is also possible to form a hinge 43 by applying adhesive 53 in a condition in which the mirror 15 and arm 42 are brought together beforehand and forming a bridge by inflow of adhesive 53 to the side of the mirror 15 from the hole of the projection 42a in the middle of the arm 42 and then separating the arm 42 and the mirror 15 as shown in FIG. 15B to a prescribed distance and curing.

Also, as shown in FIG. 16A, in the case of adhesive 53 that shows comparatively little flow (for example adhesive having a viscosity of the order of 10 Pa.s to 50 Pa.s), a method may also be employed wherein, in addition to applying the adhesive to the hole of the arm 42, adhesive 53 may be applied also to the convex seat 44 of the mirror 15, thereby positioning the adhesive 53 beforehand on the wetting face constituted by the upper surface thereof, bringing the arm 42 and the mirror 15 together as shown in FIG. 16B, and thereby reliably forming a bridge of the adhesive 53, after which the arm 42 and the mirror 15 are separated to a prescribed distance and the adhesive 53 cured, to form a hinge 43 as shown in FIG. 16C.

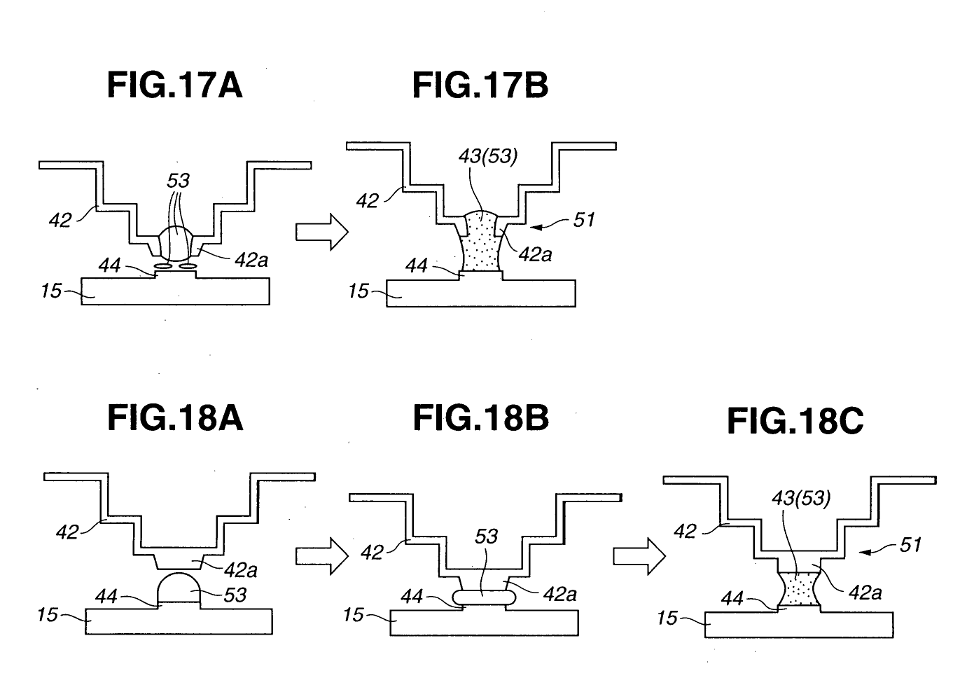

In this case, a hinge 43 may also be formed as shown in FIG. 17B, by applying adhesive 53 to the hole of the arm 42 and the seat 44 of the mirror 15 in a condition with the arm 42 and mirror 15 brought together as shown in FIG. 17A to form a bridge, after which the arm 42 and mirror 15 are separated by a prescribed distance and curing is performed.

Although, above, it was arranged for the adhesive 53 to project on the side of the seat 44 of the mirror 15 from the hole provided in the projection 42a in the middle of the arm 42, there is no restriction to necessarily providing a hole.

For example, a method could be adopted in which, as shown in FIG. 18A, for example adhesive 53 is applied to the upper surface of the seat 44 without providing a hole in the projection 42a of the arm 42, a bridge is then formed by the adhesive 53 by bringing the arm 42 and the mirror 15 together as shown in FIG. 18B, and the hinge 43 is then formed as shown in FIG. 18C by separating the arm 42 and the mirror 15 by a prescribed distance and curing the adhesive 53.

It should be noted that, although, in FIG. 18A, the case was illustrated in which the adhesive 53 was applied solely to the adhesive wetting face at the upper surface of the seat 44, i.e. solely on one side thereof, it would also be possible to apply the adhesive 53 to both of the upper surface of the seat 44 and the leading end face (facing the seat 44) of the projection 42a of the arm 42 or to apply the adhesive 53 to the surface of the leading end of the projection 42a of the arm 42.

It is also possible to repeat the operation of diminishing and increasing the distance between the mirror 15 and the arm 42 until sufficient spreading of the adhesive 53 onto the members at the wetting faces is achieved and, as a result, a hinge 43 of a suitable size is formed.

Next, a method of curing the adhesive 53 will be described.

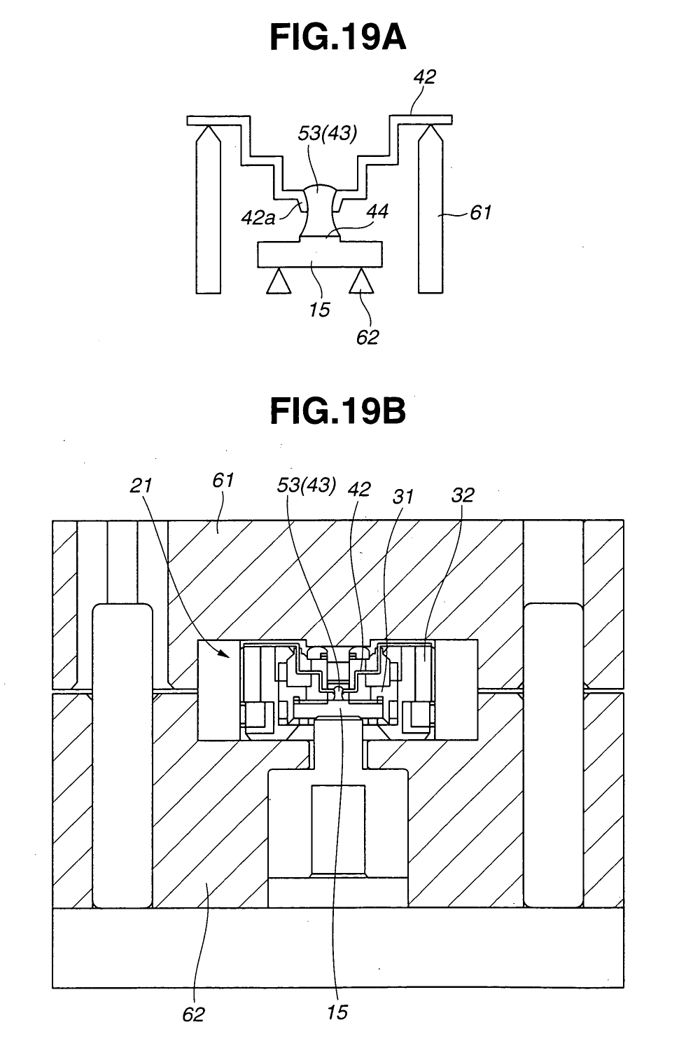

Also, if thermo-setting adhesive is employed, the hinge 43 can be made of appropriate length and the performance of the manufactured product stabilized by curing the moveable unit and fixed unit over a prescribed length when curing. FIG. 19A shows diagrammatically an example of the construction of a device using the position control method or position correction method during curing; FIG. 19B shows an example of the actual construction thereof.

As shown in FIG. 19A, basically, the position of the adhesive 53 during curing is controlled by height position setting of the arm 42, which is performed by means of an upper jig 61 and setting of the height position of the mirror 15, which is performed by means of a lower jig 62 of the jigs for position control.

More specifically, as shown in FIG. 19B, the magnet holder 32, which constitutes the fixed unit in the optical deflector 21, is clamped by means of the upper jig 61 and lower jig 62, comprising two upper and lower jigs, the coil holder 31 constituting the moveable unit is pushed upwards by a spring by means of the lower jig 62 and in the case of the upper jig 61 the magnet holder 32 is subjected to pressure by the weight of the jig; the positions of the moveable unit and fixed unit are thereby corrected.

As a result, since the position of the moveable unit and the fixed unit is fixed by means of the upper jig 61 and the lower jig 62, if, in this condition, the adhesive 53 is cured or temporarily cured, the relative position of the mirror 15 and the arm 42 where the adhesive 53 is introduced is maintained during the curing or temporal curing of the adhesive 53. Consequently, the hinge 43 of the desired length can be obtained in a stable fashion.

Next, the action of the mirror support device 14 according to this embodiment will be described.

When drive current flows in the first coil 36 through two of the four springs 33, torque about the axis of rotation Oy is generated by the magnetic field received from the magnet 47, thereby subjecting chiefly the first deformation section 33a to screw deformation and the hinge 43 to flexing deformation; in this way, the moveable unit can be tilted about the axis of rotation Oy. In this case, the angle of tilting can be adjusted by the value of the drive current.

When drive current flows in the second coil 37 through the other two of the four springs 33, torque about the axis of rotation Ox is generated by the magnetic field received from the magnet 49, thereby subjecting chiefly the second deformation section 33b to screw deformation and the hinge 43 to flexing deformation; in this way, the moveable unit can be tilted about the axis of rotation Ox. In this case, the angle of tilting can be adjusted by the value of the drive current.

As shown in FIG. 6, the beam from the semiconductor laser 24 is incident on the PBS 25 in the form of P polarized light, passes through the polarizing face 25a thereof, is incident on the lens 27 through the ¼ wavelength plate 26 and is incident on the reflecting surface 31a at the rear face of the mirror 31. The light that is reflected by the reflecting face 31a passes through the ¼ wavelength plate 26, where its plane of polarization is rotated by 90° to produce S polarized light, which is incident on the polarizing face 25a, where it is reflected before being incident on the detection surface 28a of the PSD 28.

When the mirror 15 or the mirror 31 is tilted about the axis of rotation Oy, the beam on the detecting face 28a of the PSD 28 is displaced in the Z direction in FIG. 6; when the mirror 15 is tilted about the axis of rotation Ox, the beam on the detecting face 28a is displaced in the Y direction; the output of the PSD 28 can therefore be used to detect tilting of the mirror 15 in two directions.

Also, since in this embodiment the hinge structure 51 is constituted as a structure that supports the moveable unit in a freely rotatable manner about axes of rotation Ox, Oy in two orthogonal directions and can be formed in a simple manner by introducing the adhesive 53 between the arm 42 and the middle portion of the rear face of the mirror 15, where it is cured to form a bridge, and the shape and size of the bridge that is formed with the arm 42 are then prescribed or controlled by formation of the seat 44 in the middle of the rear face of the mirror 15, hinges (or pivots) 43 of matching shape and size can be formed in a stable fashion, making it possible to manufacture moveable units i.e. mirror support devices 14 with stable characteristics.

More specifically, advantages are obtained in respect to the following items, compared with the prior art example.

(a) Cross-Sectional Shape of the Hinge

Since the hinge is made of silicone-based resin selected so as to provide an appropriate coefficient of elasticity, the hinge can be formed in a continuous curve, utilizing the fluidity of the adhesive, enabling a shape to be produced in which stress concentrations during operation do not occur.

(b) Coefficient of Elasticity (Material Properties)

A wide range of hardness, from 16 A to 70 A, can be selected by choice of the silicone adhesive.

(c) Molding Stability and Costs

The hinge shape is determined by the adhesive wetting surfaces, and by hinge molding (adhesive curing) in a condition in which correction is effected in respect to the length direction, a hinge of stable shape and size can be produced. Also, the hinge can be manufactured at low cost.

(d) Changes Relating to Durability (Change of Material)

Regarding durability, by employing addition-type silicone adhesive, material properties can be achieved such that deformation due to secular contraction does not occur, so there is no effect on a mirror support such as a galvano-mirror in terms of change of characteristics.

(Second Embodiment)

Next, a second embodiment of the present invention will be described. Since the hinge structure of this embodiment has basically the same construction as in the first embodiment, except for some differences, this may be termed a modified example of the first embodiment.

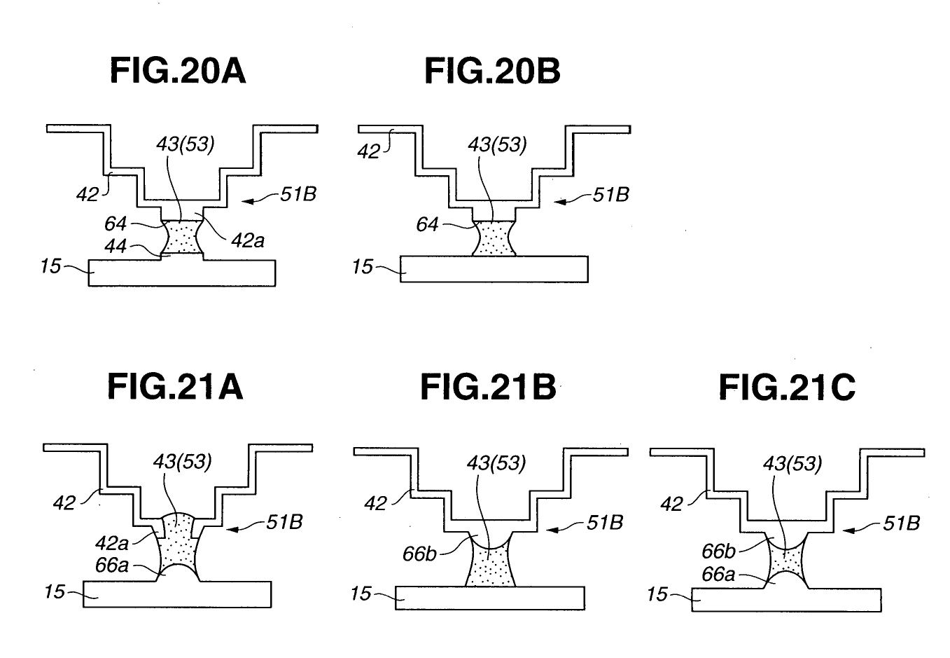

FIG. 20A shows the hinge structure 51B according to a second embodiment of the present invention. In this embodiment, as shown in FIG. 20A, a seat 44 is provided on the mirror 15 and a seat 64 is also formed on the middle projection 42a of the arm 42.

Thanks to the provision of respective seats 64, 44 on the leading end face of the middle projection 42a of the arm 42 and in the middle of the rear face of the mirror 15 facing and adjacent thereto in this way, better stabilization of the shape and size when the bridge between these is formed by adhesive 53 can be achieved. That is, hinge structures 51B with uniform characteristics and matching shape and size can be formed when hinges 43 are formed by curing the adhesive 53.

A hinge structure 51B of better precision than in the first embodiment can thereby be provided. It should be noted that, in the case of FIG. 20A, it is unnecessary to provide a hole in the middle projection 42a of the arm 42.

It should be noted that, as a modified example of this embodiment, it would be possible to form a seat 64 on the arm 42 only, as shown in FIG. 20B.

Further modified examples are summarized below.

In FIG. 21A to FIG. 21C, the hinge shape that is formed may be stabilized and wettability improved by providing a convex portion of hemispherical shape on the side of the arm 42 and/or on the side of the mirror 15. The size of the surface that is wettable by the adhesive 53 is increased by such provision of a hemispherical surface in the region where the adhesive is applied.

In this way, by making the surface hemispherical, the beneficial action and effect are obtained that the area that is wettable with the adhesive 53 is increased and breaking strength at the interface is thereby increased.

Specifically, FIG. 21A shows the case where the mirror 15 is formed with a hemispherical surface 66a and the arm 42 is of a shape provided with a projection 42a having a hole; FIG. 21B shows the case where the arm 42 is formed with a hemispherical surface 66b and no seat 44 or the like is formed on the mirror 15; FIG. 21C shows the case where hemispherical surfaces 66a and 66b are provided on both the mirror 15 and the arm 42.

As described above, in the cases of FIG. 21A to FIG. 21C, the surface that is wettable with the adhesive is increased by making this surface hemispherical and breaking strength at the interface can thereby be increased, making it possible to increase the mechanical strength of the mirror support device with respect to vibration or other factors.

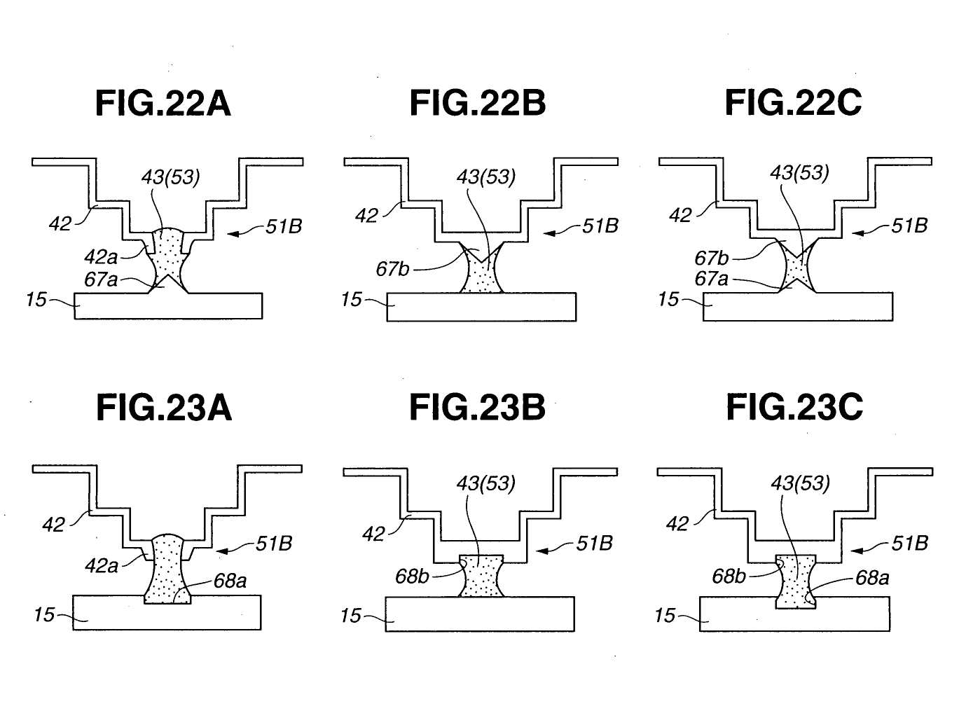

While FIG. 21A to FIG. 21C show the case of hemispherical surfaces, FIG. 22A to FIG. 22C show the case of conical surfaces. In this case also, the surface that is wettable by the adhesive 53 is increased by making the surface conical and breaking strength at the interface can thereby be increased and, in addition, application of the adhesive 53 can be facilitated.

Specifically, FIG. 22A shows the case where the mirror 15 is formed with a conical surface 67a and the arm 42 is of a shape provided with a projection 42a having a hole; FIG. 22B shows the case where the arm 42 is formed with a conical surface 67b and no seat 44 or the like is formed on the mirror 15; FIG. 22C shows the case where conical surfaces 67a and 67b are provided on both the mirror 15 and the arm 42.

In this case also, the hinge 43 can be formed in a stable fashion and mechanical strength can be increased.

Also, in the case of FIG. 23A to FIG. 23C, the mirror 15 or the arm 42 is made of a shape formed with a concave, and this concave is employed as the application surface, thereby restricting spreading of the wettable surface. Consequently, even if rather too much adhesive is applied, or adhesive 53 is employed that flows readily, the shape of the hinge 43 can still be formed in stable fashion.

Specifically, FIG. 23A shows the case wherein a concave 68a is formed on the side of the mirror 15 and the arm 42 is of a shape provided with a projection 42a having a hole; FIG. 23B shows the case where the arm 42 is formed with a concave 68b and no seat 44 or the like is formed on the mirror 15; FIG. 23C shows the case where concaves 68a and 68b are provided on both the mirror 15 and the arm 42.

In this case also, the hinge 43 can be formed in a stable fashion and mechanical strength can be increased.

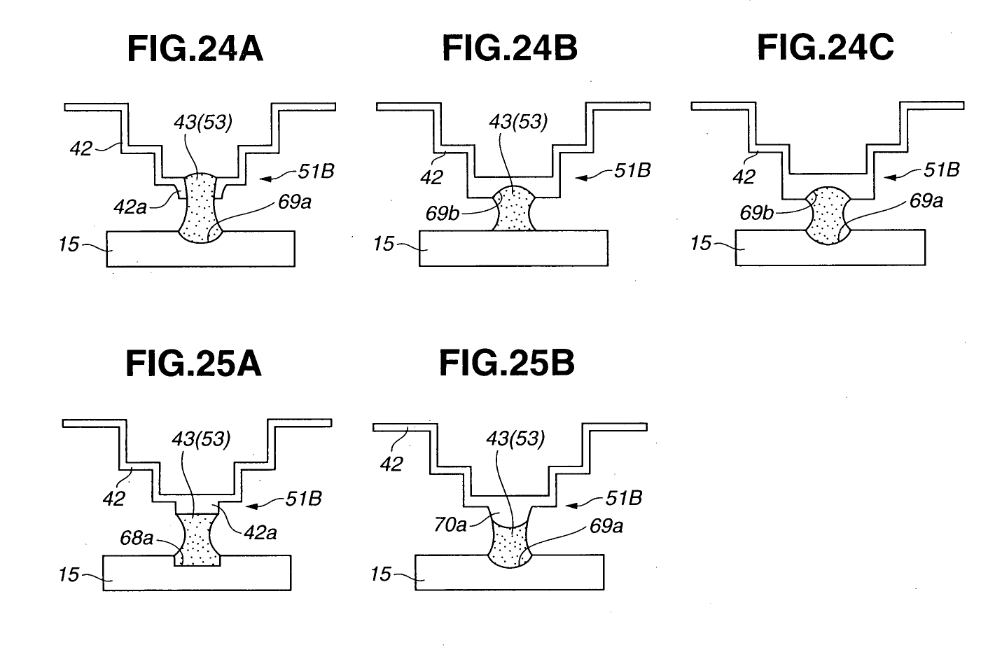

Also, FIG. 24A to FIG. 24C show the case where the shape of the wettable surface is stabilized and the hinge 43 can thus be formed in stable fashion, by providing a spherical concave in the mirror 15 or the arm 42.

Also, by making the surface of application of a spherical concave shape, spreading of the wettable surface can be restricted; consequently, even if rather too much adhesive is applied, or adhesive 53 is employed that flows readily, the shape of the hinge 43 can still be formed in stable fashion. Processing is also facilitated, compared with the case of for example FIG. 23A to FIG. 23C.

Specifically, FIG. 24A shows the case wherein a spherical concave 69a is formed on the side of the mirror 15 and the arm 42 is of a shape provided with a projection 42a having a hole; FIG. 24B shows the case where the arm 42 is formed with a spherical concave 69b and no seat 44 or the like is formed on the mirror 15; FIG. 24C shows the case where concaves 69a and 69b are provided on both the mirror 15 and the arm 42.

In this case also, the hinge 43 can be formed in a stable fashion and mechanical strength can be increased.

In this description a spherical concave shape was described, but a non-spherical concave shape or curved concave shape could be employed.

Also, in FIG. 25A and FIG. 25B, the mirror 15 or arm 42 is formed of a concave/convex combination.

Specifically, by adopting a combination of a concave and a convex portion, compared with the case of a combination of concaves, the faces can be made to approach more closely when the hinge 43 is formed, thereby making it possible to make the adhesive 53 adhere appropriately.

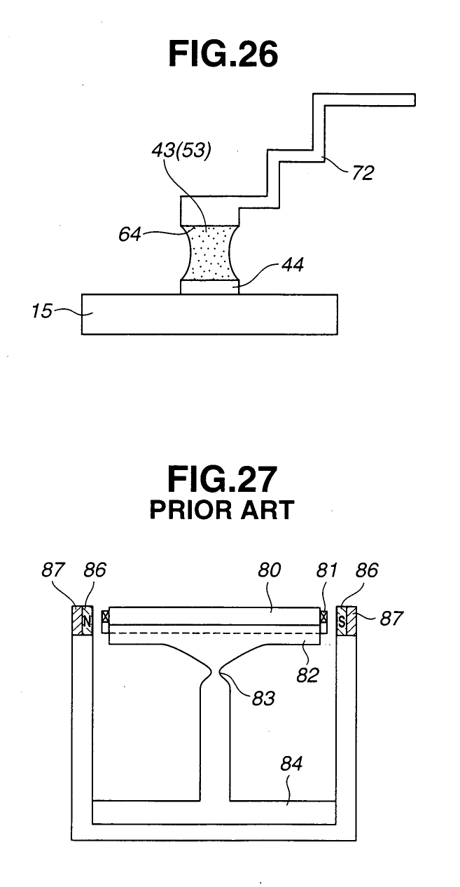

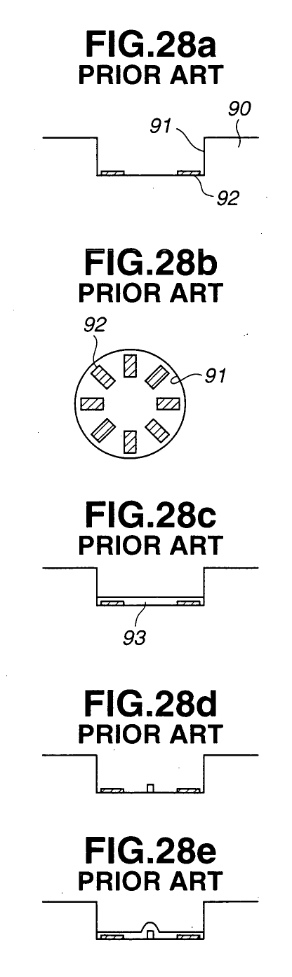

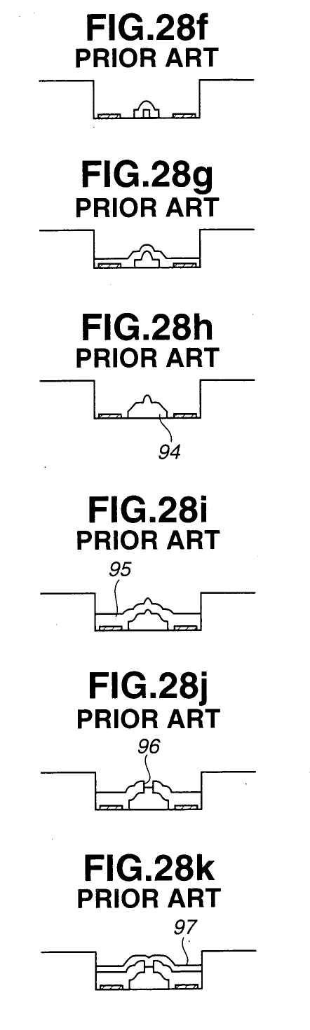

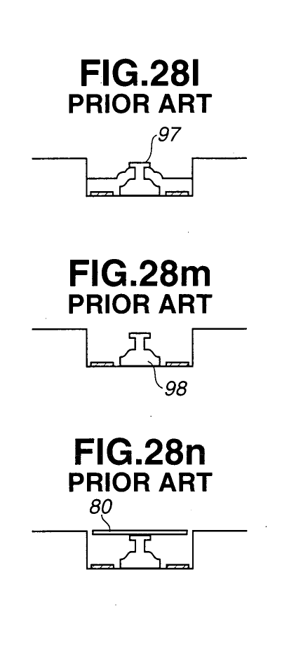

Specifically, in FIG. 25A, a concave 68a is formed on the mirror 15 and a concave portion 42a, not having a hole, is formed on the arm 42. In FIG. 25B, a spherical concave 69a is formed on the mirror 15 and a spherical convex portion 70a is formed on the arm 42. Also, although, in the embodiments or modified examples described above, the case of a double-handled arm 42 was illustrated, a single-handled arm 72 as shown in FIG. 26 could be employed.

In this case, the space available for application of adhesive can be increased, facilitating manufacture.

It should be noted that, although, in FIG. 26, the case where a seat 64 was formed on the arm 72 is illustrated, other shapes could be adopted. Also, although the case where a seat 44 was formed on the mirror 15 is illustrated, other shapes could be adopted.

In the embodiments or modified examples described above, in cases where durability is not required or positional stability is not important or cases where curing at normal temperature is desired, single-liquid RTVs such as Super X (manufactured by Cemedine), TB 1530C (ThreeBond), TB 1220D (ThreeBond), SE 9186L (Toray/Dow Corning), or SE 9186 (Toray/Dow Corning) or the like could be employed.

If this is done, since the viscosity is higher, a hinge 43 of smaller thickness can be formed.

Substantially the same beneficial effect is basically provided by the second embodiment as with the first embodiment.

As the field of utilization of these embodiments, in the above description, optical communication was described, but they could also be applied to optical deflectors employed for example in measurement equipment or pickups for optical recording, for example.

Also, although, in the embodiments described above, a moving coil was employed, these embodiments could likewise be applied to a moving magnet.

Also, although, in the embodiments described above, a mirror support device that supports a mirror 15 that is freely rotatable about two axes i.e. a biaxial galvano-mirror was described, they could likewise be applied to a support device that is freely rotatable about a single axis. Also, embodiments formed for example by a partial combination of the embodiments described above likewise fall within the scope of the present invention.

Also, although the region where the adhesive 53 was applied was described for the case of the mirror 15 and arm 42, it would be possible for the adhesive to be applied between the moveable unit and the fixed unit. Also, it would be possible for this to be employed for supporting using a hinge other types of optical element or optical component, not merely the mirror 15.

In the present invention, it is clear that a broad range of different embodiments could be constructed in accordance with the present invention without departing from the spirit and scope of the invention. Such specific embodiments of the present invention are not therefore to be restricted otherwise than as specified by the appended claims.

What is claimed is:

1. A mirror support device comprising:
a moveable unit having at least one mirror;
a support unit that supports this moveable unit so as to be tiltable about at least a first axis with respect to a fixed member;
a first drive unit that drives the moveable unit about the first axis; and
a hinge introduced and formed between a first location and a second location, positioned in substantially the middle of the moveable unit, the first location or second location or both locations comprising a concave face or a convex face.

2. The mirror support device according to claim 1, wherein the first location is provided on the moveable unit.

3. The mirror support device according to claim 1, wherein the second location is provided on the support unit.

4. The mirror support device according to claim 1, wherein the hinge is provided substantially perpendicular with respect to the reflecting face of the mirror.

5. The mirror support device according to claim 1, wherein the hinge is provided in the vicinity of the drive center of the first drive unit.

6. The mirror support device according to claim 1, wherein the hinge is provided in substantially the middle of the moveable unit, at the rear face opposite to the reflecting face of the mirror.

7. The mirror support device according to claim 1, wherein the hinge is provided in the vicinity of the first axis.

8. The mirror support device according to claim 1, wherein the hinge is provided in the vicinity of the center of gravity of the moveable unit.

9. The mirror support device according to claim 1, wherein the hinge has a damping function.

10. The mirror support device according to claim 1, wherein the hinge comprises silicone adhesive.

11. The mirror support device according to claim 10, wherein the silicone adhesive is addition-type silicone adhesive.

12. The mirror support device according to claim 11, wherein the addition-type silicone adhesive is a single-liquid addition-type silicone adhesive.

13. The mirror support device according to claim 1, wherein the hinge has a linearly symmetric shape with respect to a straight line substantially perpendicular to the mirror and passing through the center of the hinge.

14. The mirror support device according to claim 1, wherein an aperture is provided at the first location and/or the second location and the hinge is arranged so as to bury the aperture.

15. The mirror support device according to claim 1, comprising a second support member that rotatably supports the mirror about the axis of rotation.

16. The mirror support device according to claim 15, wherein the second support member extends in a direction substantially parallel with the reflecting face of the mirror passing through the vicinity of the hinge.

17. The mirror support device according to claim 15, wherein the second support member has the function of supplying power to the moveable unit.

18. The mirror support device according to claim 1, wherein the support member supports the moveable unit with respect to the fixed member so as to be tiltable about a second axis that is substantially orthogonal to the first axis.

19. The mirror support device according to claim 1, wherein the first drive unit comprises a coil provided on the moveable unit and a magnet provided in the periphery of the coil.

20. The mirror support device according to claim 19, wherein the coil comprises a first coil and a second coil formed so as to sandwich therebetween a second support member that rotatably supports the mirror about the first axis.

21. A mirror support device comprising:
a moveable unit having at least one mirror;
a support unit that supports this moveable unit so as to be tiltable about at least a first axis with respect to a fixed member;
a first drive unit that drives the moveable unit about the first axis; and
a hinge introduced and formed between a first location and a second location, positioned in substantially the middle of the moveable unit, when the hinge is cured, curing being performed while the relative position of the first location and the second location is maintained.

22. A mirror support device comprising:
a moveable unit having at least one mirror;
a support unit that supports this moveable unit so as to be tiltable about at least a first axis with respect to a fixed member;
a first drive unit that drives the moveable unit about the first axis; and
a hinge introduced and formed between a first location and a second location, positioned in substantially the middle of the moveable unit, the material of the hinge being addition-type silicone adhesive.

23. The mirror support device according to claim 1, wherein the support unit supports the moveable unit with respect to the fixed member so as to be tiltable about the second axis,
the mirror support device further comprising a second drive unit that drives the moveable unit about the second axis.

24. A mirror support device comprising:
a moveable unit having at least one mirror;
supporting means that supports this moveable unit so as to be tiltable about at least a first axis with respect to a fixed unit;
a first-drive unit that drives the moveable unit about the first axis; and
a hinge introduced and formed between a first location constituting the fixed unit and a second location constituting the moveable unit, positioned in substantially the middle of the moveable unit, the first location or second location or both locations comprising a concave face or a convex face.

25. A mirror support device comprising:
a moveable unit having at least one mirror;
a support unit that supports this moveable unit so as to be tiltable about at least a first axis with respect to a fixed unit;
a first drive unit that drives the moveable unit about the first axis; and
a hinge introduced and formed between a first location constituting the fixed unit and a second location constituting the moveable unit, positioned in substantially the middle of the moveable unit; and
a control unit that controls the shape and/or size of the hinge formed by the introduction, spanning between the first location and second location.

26. The mirror support device according to claim 25, wherein the control unit is a concave-surfaced or convex-surfaced unit formed at the first location or second location or both locations.
